(19) United States
(12) Patent Application Publication
(10) Pub. No.: US 2018/0218413 A1
(43) Pub. Date: Aug. 2, 2018

(54) REVENUE SPLIT WITH USER

(71) Applicant: Hyun Hwan An, Grinnell, IA (US)

(72) Inventor: Hyun Hwan An, Grinnell, IA (US)

(21) Appl. No.: 15/707,215

(22) Filed: Sep. 18, 2017

Related U.S. Application Data
(63) Continuation-in-part of application No. 15/420,224, filed on Jan. 31, 2017.

(51) Int. Cl. G06Q 30/02; G06Q 50/00; G06Q 30/04

(52) U.S. Cl. CPC G06Q 30/0279; G06Q 30/0242; G06Q 30/04; G06Q 30/0273; G06Q 50/01

(57) ABSTRACT

The present invention comprises a method and means for fundraising, particularly crowd-funding. The inventive method provides a three-party donation regime comprising a donor and a fundraiser and a user. Stories are submitted to the system for selection; the fundraiser selects stories it believes will be popular or have a desirable message. The donor selects a story and associates the donor's advertisement with the story. The ad is then presented with the story to users that select and view the story. When the story selected by the donor is the same story selected by the fundraiser then, for every time the donor's advertisement is presented, the donor pays a fee to the fundraiser. In an alternative embodiment, a portion of the fee paid by the donor to the fundraiser is distributed to the viewer of the story.

### CROSS REFERENCE TO RELATED APPLICATION

This application is a continuation in part of United States Patent and Trademark Application Ser. No. 15/420,224 which was filed on Jan. 31, 2017, all of which are fully incorporated by reference herein.

### BACKGROUND

Fundraising by enticing donations from donors having interests aligned with the cause seeking donations has become an ever more important way for certain interests to be able to move forward. The key to fundraising, however, is two-fold; to attract a donor the first time and to entice that donor either to donate large amounts of money or to donate multiple times. The corporate donor is likely to have more funds at its disposal to donate than a person with ordinary income, however, its business interests are its top priority and compete for the use of those funds. Further, a corporation is more likely to donate where its donation will be noticed by the audiences most relevant to its business interests. This is why corporate donors are often acknowledged by, for example, listing the level of donation provided by it, or a plaque on a building identifying corporate sponsors of that building, etc. The more exposure of the donor and the favorability of that exposure to its intended audience, the more likely the corporate-type donor will be to participate in a given cause.

Individual donors contributing large sums of money often are motivated by acknowledgement of their contributions in the form of a permanent plaque or a listing somewhere. However, today's younger generation coined “millennials” (and others that are not of that generation by birth) have completely different decision-making patterns and motivations to purchase or donate than prior generations. Many are fairly young at this point in time having incomes that are comparatively small, and they seem to be a bit more aligned with philanthropic tendencies and motivations than generations of the past. In addition, like generations that have preceded them, their earning (and donating power) has yet to reach its peak which is still decades away. Millennials, as a group, are not as motivated as other generations to seek the highest income available by working long hours simply in return for money, where income is the main reward for effort. They are, instead, more motivated by lifestyle opportunities and a group mentality. Millennials are also far more socially conscious and aware than their predecessors. In addition, millennials and many others divide their entertainment and shopping experiences among the thousands of websites available including Facebook, Twitter, and other electronic information sharing/providing sites, rather than a relatively finite set of television stations and targeted radio stations. Those seeking donations from this generation by traditional fundraising means—and from people outside this generation who are like-minded—must invest heavily in the reach of their message and its content, understanding that although millennials and younger people in general may be reached by a well-constructed message, the resulting individual donation is likely to be small.

In addition to their differing information gathering and philanthropic motivations and how they act on them, millennials also have their very own communications style and tools. The vast majority obtain most of their information online rather than through television and radio like their predecessors. Many consume news via a favorite website, and belong to on-line communities that have participating members or viewers based on like interests. Further, rather than reading a print magazine or watching a television show sponsored through advertising, entertainment can be accessed directly, often with little or no participation by advertisers. Further, many people older than millennials are beginning to enjoy and take advantage of social media and other tools as a means to stay connected with people of similar interests as well as a means of entertainment sourcing.

### SUMMARY OF THE INVENTION

Those seeking charitable donations as a means to fund a cause are faced with a huge and very new challenge. The traditional means of raising funds through purchasing advertising space on television and radio, or even print advertising, are very unlikely to effectively reach young adults and a number of potential donors from other generations. And, reaching enough people effectively through on-line advertising by sponsoring a website or a product is equally challenging due to the vast number of websites competing for the attention of the online population. Further, while reaching this group by presenting an appealing message may, indeed, motivate donations by individuals, most likely, these donations will be small. The size of the donation is reduced because the donors will be bombarded by so many seeking donations; the donor will make smaller donations in order to contribute to more causes. And, of course, for the most part the newer generation has yet to meet its peak income and be able to make sizable, individual donations.

The youngest generations gather information and are entertained by completely different sources and have differing motivations and information gathering styles. They gather and share information electronically by using a variety of tools and platforms such as on-line shopping sources sponsored by a single entity or a platform providing access to goods from multiple sources. Because they are not physically present to try the product, or touch and feel the product, these buyers pay attention to ratings and opinions of the product provided by others. So, too, older generations are learning to take advantage of the on-line opportunities to communicate with others with like interests and common causes, and to gather information and others' opinions in order to make a purchasing decision. Today's world is full of people who are communicating with each other in innovative ways many of whom are joining on-line communities of like-minded individuals; checking boards and websites dedicated to relatively narrow interests to gain knowledge, and to connect with others.

Tools are often provided for “rating” or otherwise commenting on posted material. This group of consumers pays attention to its cohort's opinions, sometimes relying on those posted opinions as the most reliable source of information regarding a product's quality or the entertainment value of a new movie.

The present invention capitalizes on on-line communications tools and the evolving manner of communicating and socializing on-line. In particular, the present invention employs an on-line community wherein fundraisers can post stories crafted to present a cause and entice the reader/viewer to want to help or otherwise support that cause. Alternatively, these stories may have little or no connection to the cause supported by the fundraiser seeking funds. The user or viewer in the on-line community may view any story that they find to be of interest and, either when finished or at various points during the viewing or reading of the story, the participant is presented with an opportunity to help or support a cause by voluntarily viewing an advertisement sponsored by a donor/sponsor entity. Most often, the ad will be for a service or product offered by or somehow connected with the donor/sponsor entity. In exchange for the participant's viewing of the advertisement, the sponsor/donor entity will donate a certain amount to the associated cause of the fundraiser, thereby collected by the fundraiser as a donation. The inventive arrangement essentially creates a three-party donation scheme rather than the traditional two-party arrangement.

In a second embodiment, after the viewer views the story (or at some time during the viewing of the story), the viewer is presented with an opportunity to view the advertisement. Further, the viewer may be provided with a tool or tools with which to indicate his opinion of the advertisement and/or the story. Of course, there are other means online including unrelated online communities that the viewer may also use to share his enthusiasm for the story and/or the advertisement. In any case, the viewer is able to communicate his opinion of the story and/or of the advertisement via voting buttons, rating scales, written critique, etc. which the viewer can assign and associate with the story or the ad or both. These ratings and opinions are made available to other potential viewers. Other potential viewers will see the viewers' opinion indicators, and are enticed to view the story and the attendant ad. In one embodiment, functionality is provided so that the viewer may post a question about the story for response by its author or its sponsor. Alternatively, the system may allow the viewer to simply elect to view the ad (without the story), if she so chooses. Where a plurality of opinion indicators for a particular story or ad exist, at least some may I be consolidated and associated with the ad or story so that potential other viewers can select what to view according to the opinion indicators. In this manner, the story or ads with the “highest” ratings can be sought and/or identified by other potential viewers. The viewer may also be provided means to share his opinion; the opinions can be associated together and used to entice still others to view the story and/or advertisement, thereby increasing the amount of funds raised. Finally, it is expected that a viewer may post an opinion on a completely unrelated site where members of an unrelated on-line community may read about the ad or the story and be enticed to seek them out in response to the viewer's recommendations or critique.

Each time the advertisement is viewed, the system increases the view count for that advertisement. The advertiser donates to the fundraiser a pre-determined amount of each view of the advertiser's advertisement. This amount may vary depending on the number of viewers to date, the source of each new viewer, the rating of the advertisement by the viewers, or any of several other measures indicating the success of the ad relative to the number of times it is viewed. In some embodiments the donor may set a cap on the total possible donation such that the number of times the ad may be viewed (and donation be owed by the sponsor) will be limited by the system. In embodiments a single viewer may be limited to viewing a given ad only a certain number of times. Finally, the system is able to accommodate initial, full payment by the sponsor of the amount it is willing to donate, keep track of the number of views of the ad so sponsored, and calculate a refund for the sponsor if the number of views of the sponsored ad and the per view donation amount, together, do not meet the amount sponsored and deposited by the sponsor.

In another embodiment, whenever the advertiser is caused to donate funds to the fundraiser as a result of a viewer's view of the associated story or ad, the advertiser also pays the viewer. Alternatively, the fundraiser pays over to the viewer a portion of the donated funds the fundraiser receives from the donor. In either case, this payment may be a flat rate, or may be a set percentage of the amount the advertiser donates to the fundraiser, or may be on some type of sliding scale depending on the number of views so far. Alternatively, the fundraiser may select a rate or proportion of the amount paid by the advertiser which it directs to be paid over to the viewer.

### BRIEF DESCRIPTION OF THE DRAWINGS

FIG. 1 provides a schematic outlining the flow of stories, donations, and activities of participants in the on-line community;

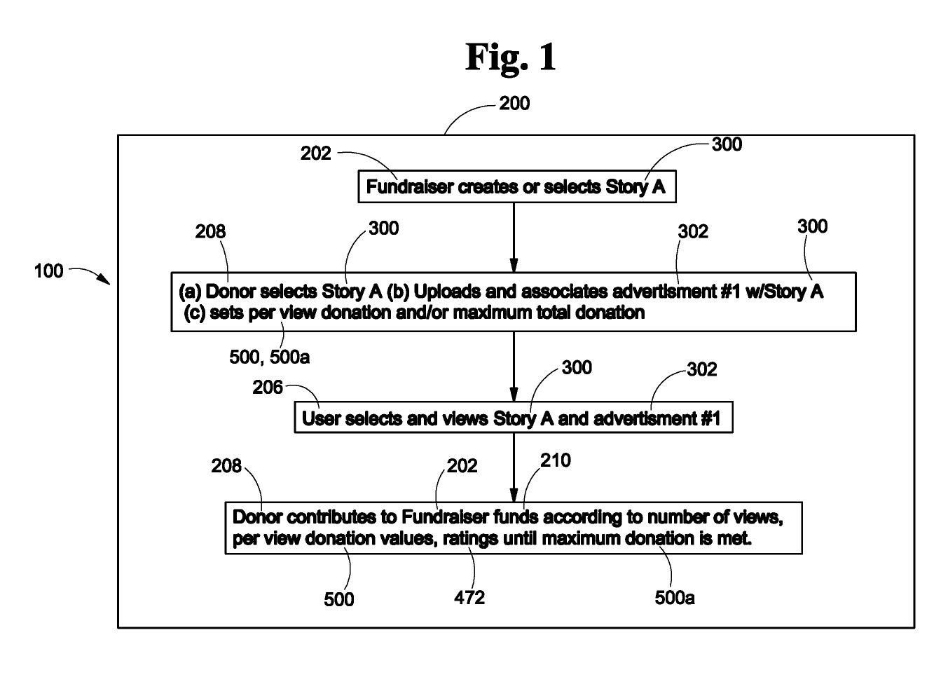

FIG. 2A illustrates the registration process for users;

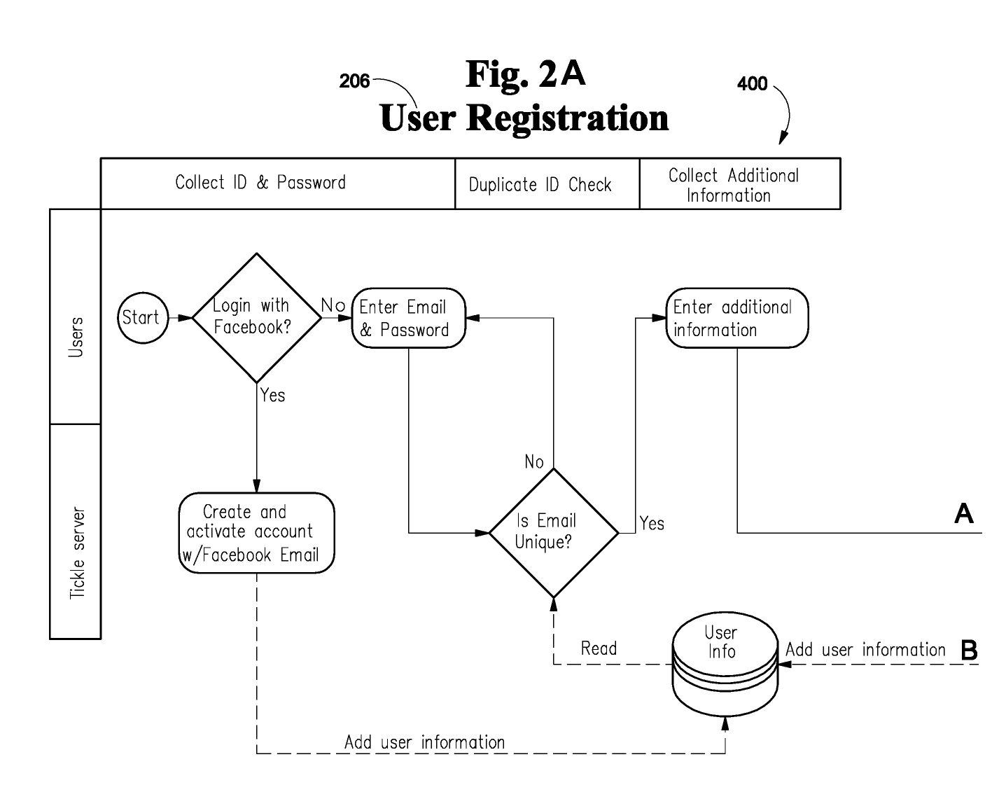

FIG. 2B illustrates the registration process for users and is a continuation of FIG. 2 and FIG. 2A;

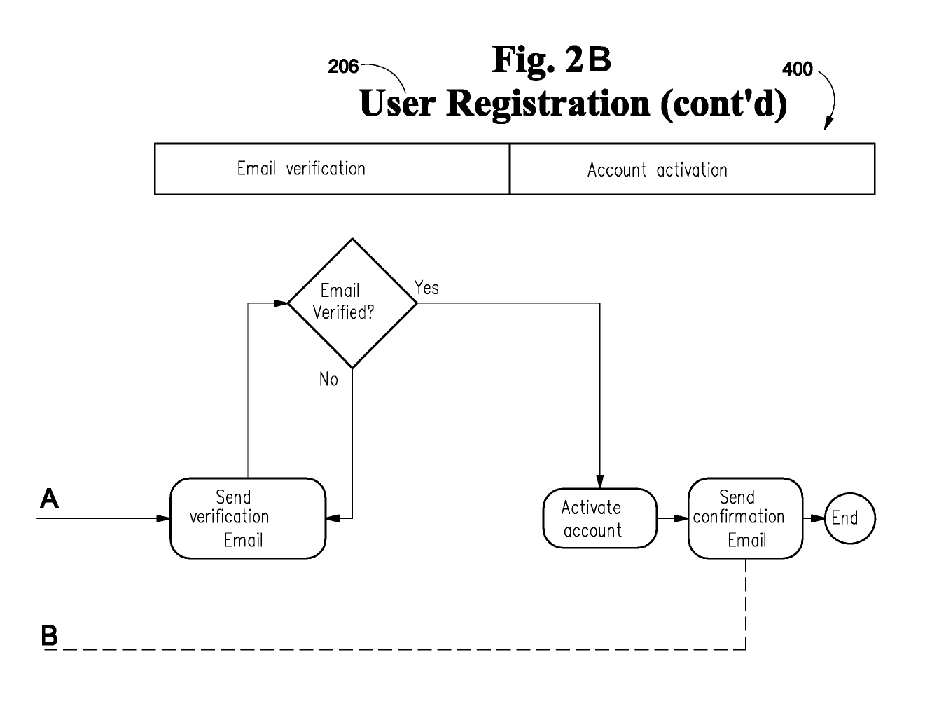

FIG. 3A illustrates the registration process for companies;

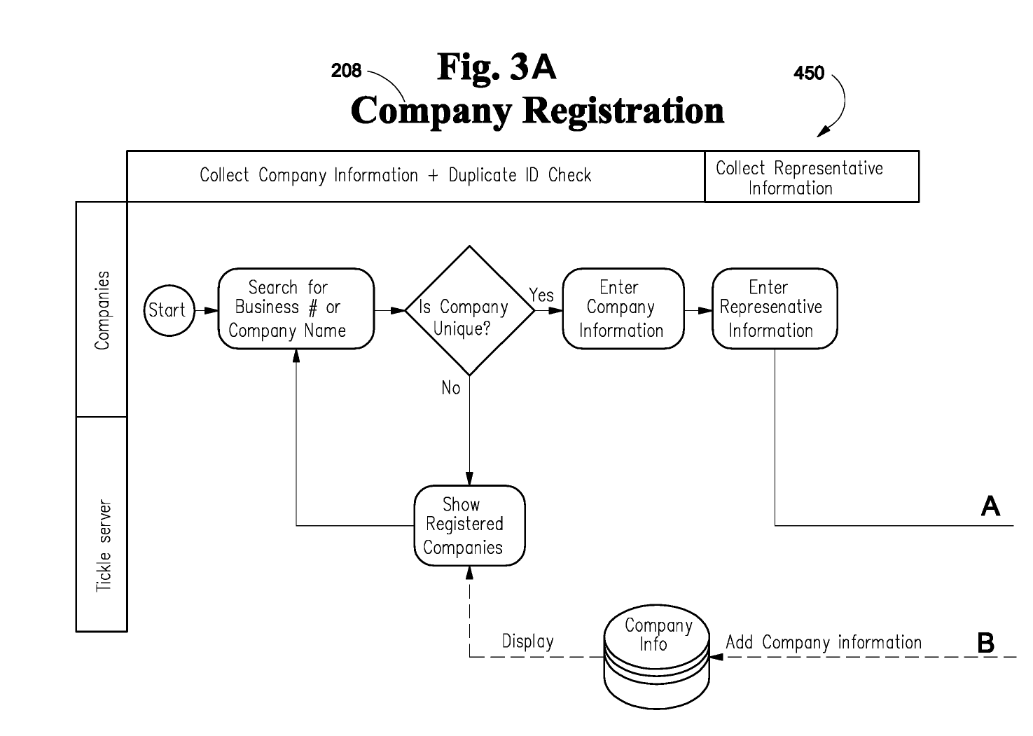

FIG. 3B illustrates the registration process for companies and is a continuation of FIG. 3A;

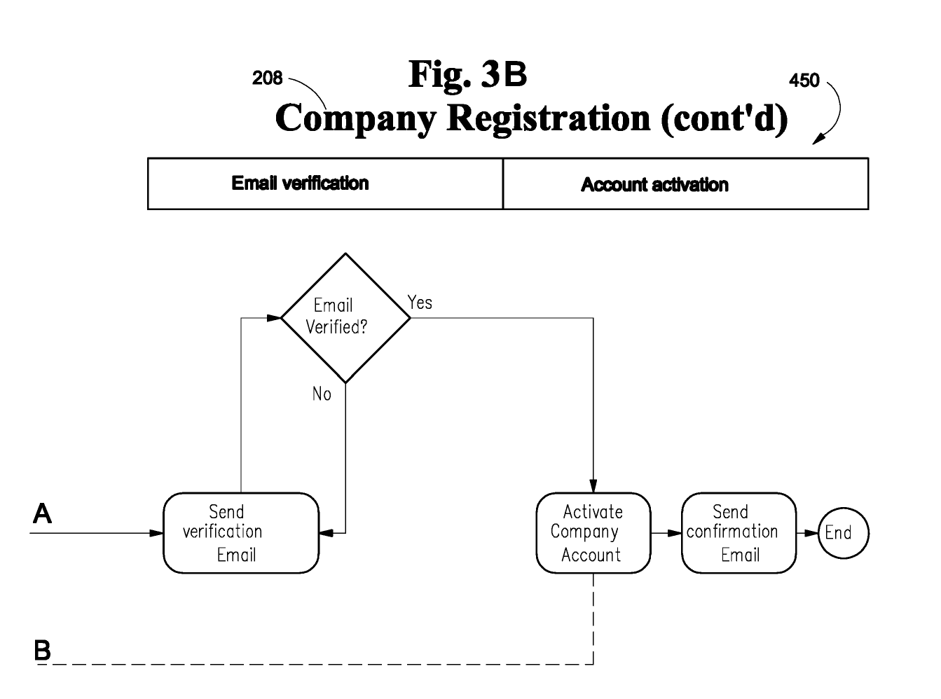

FIG. 4A provides a process overview of sponsor story selection, goal setting, deposit, and set up;

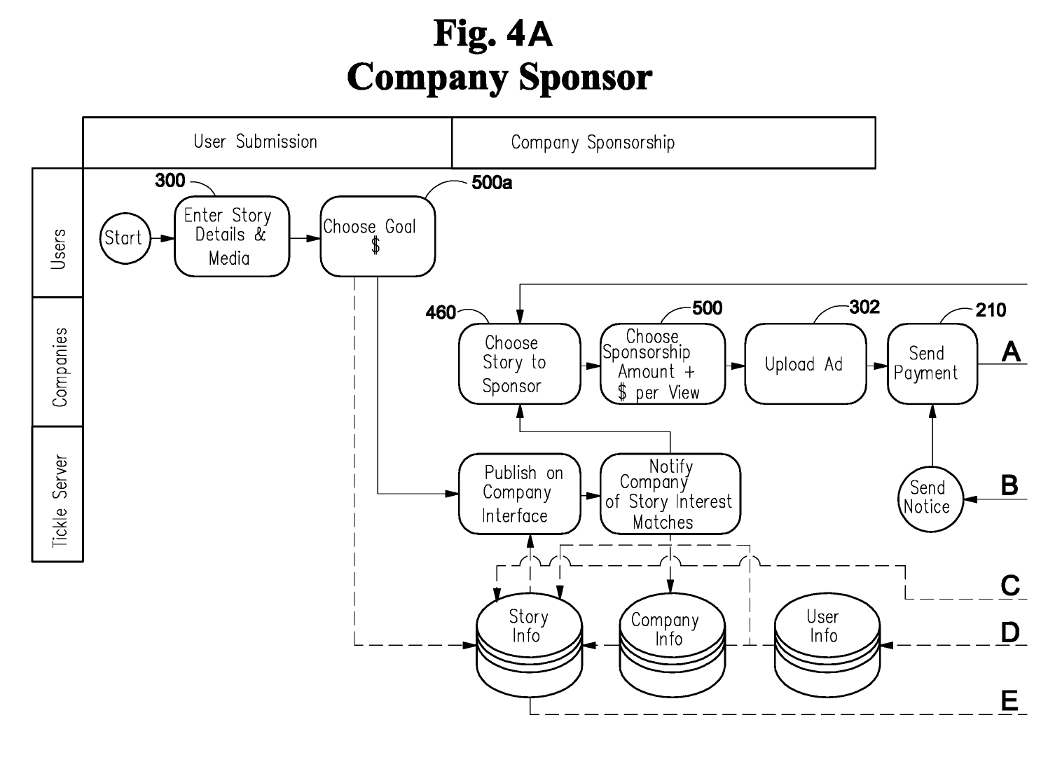

FIG. 4B provides a process overview of sponsor story selection, goal setting, deposit, and set up, and is a continuation of FIG. 4A;

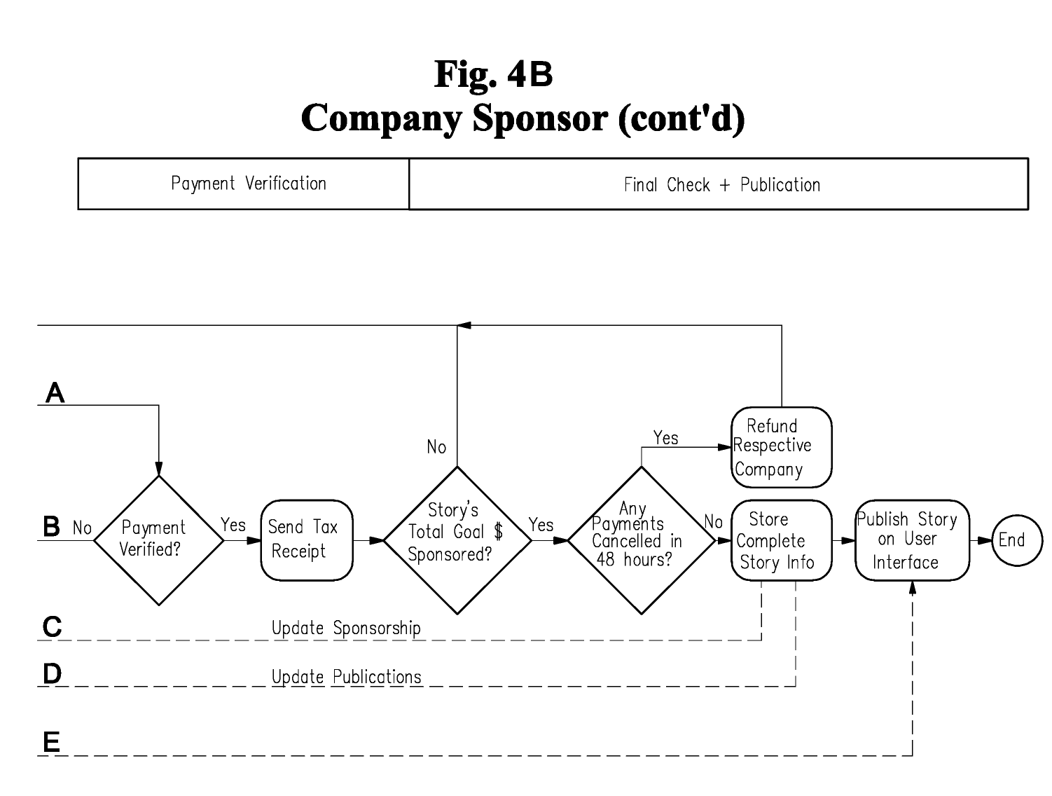

FIG. 5A shows user interaction options, and data storage related to each story viewed, ad selected, and donation;

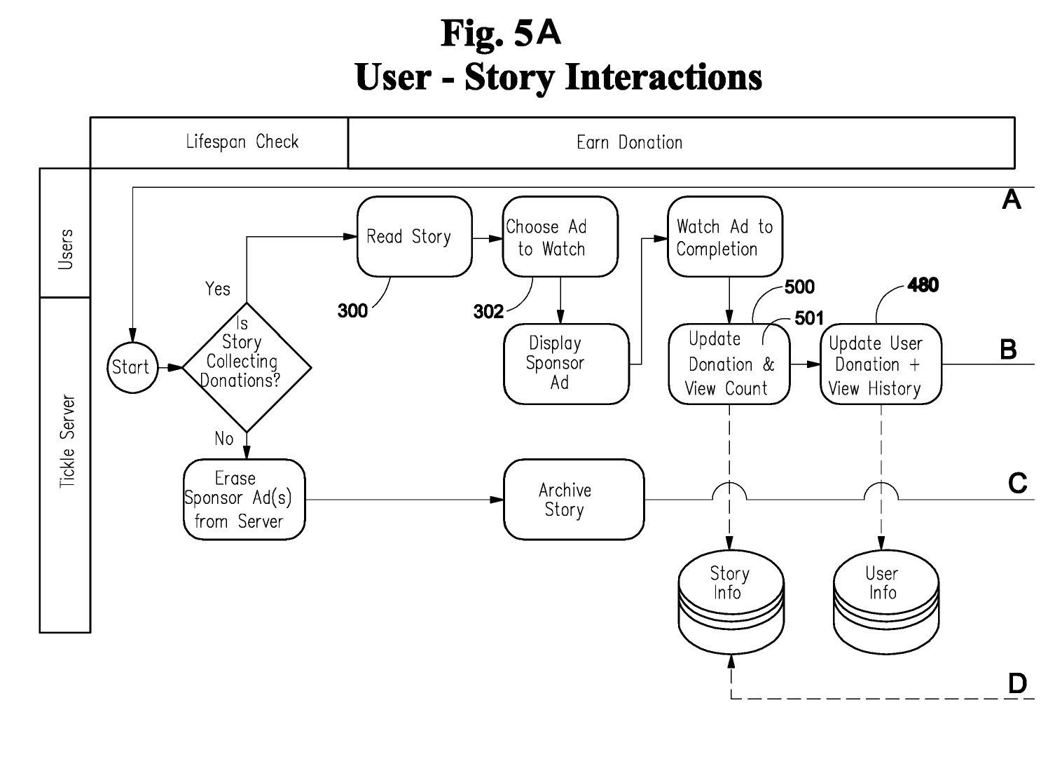

FIG. 5B shows user interaction options, and data storage related to each story viewed, ad selected, and donation and is a continuation of FIG. 5A;

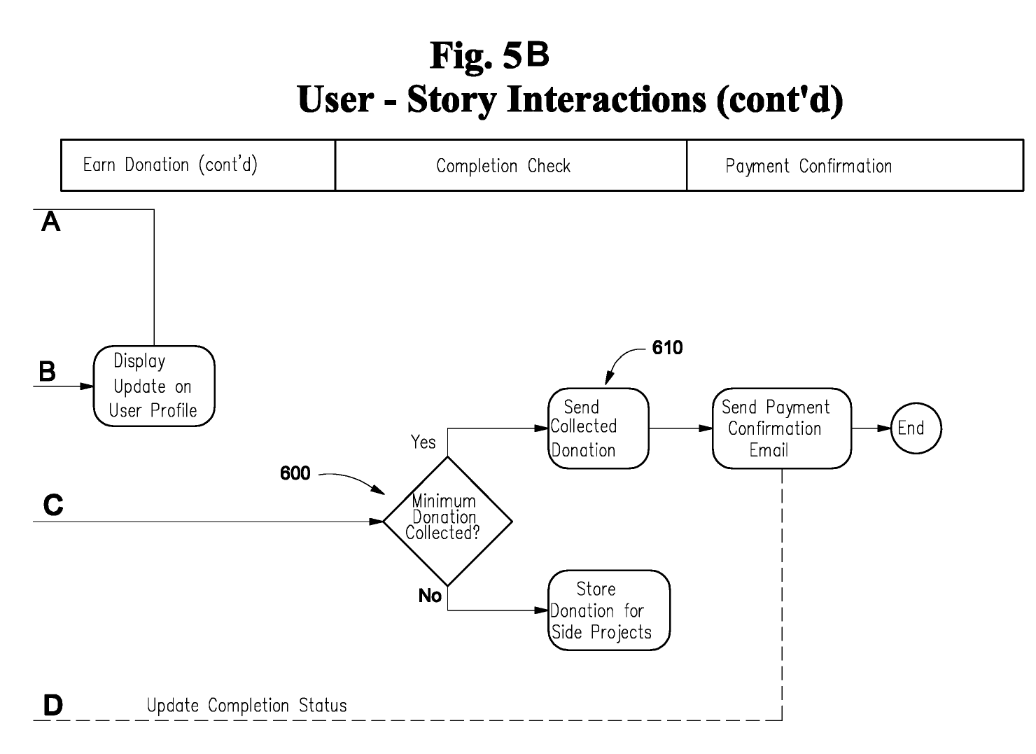

FIG. 6 is an example data points list for data regarding each of the three participant categories in the on-line community, fundraiser, viewer, donor/sponsor;

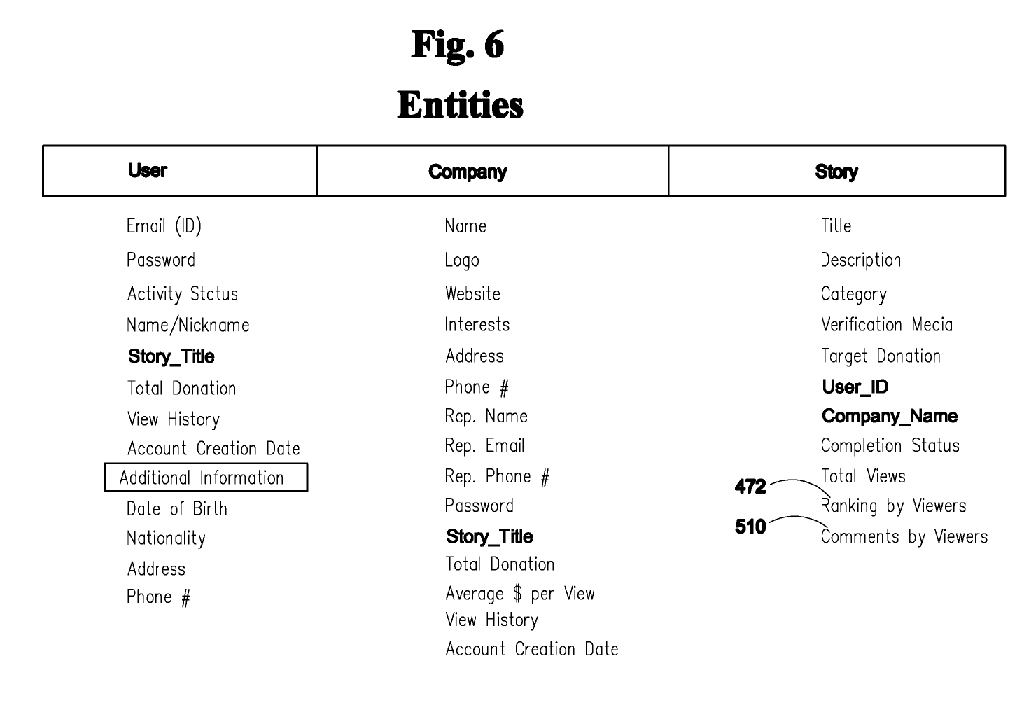

FIG. 7 illustrates rankings detail per sponsor;

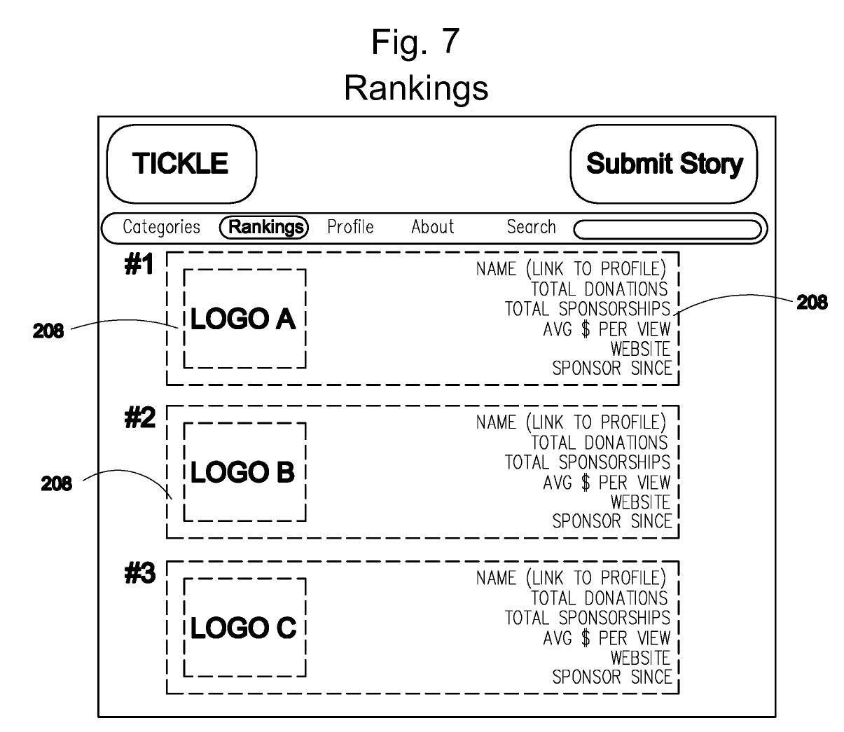

FIG. 8 shows an example screen providing details of activity related to a particular story, its sponsors, number of viewers, and donations;

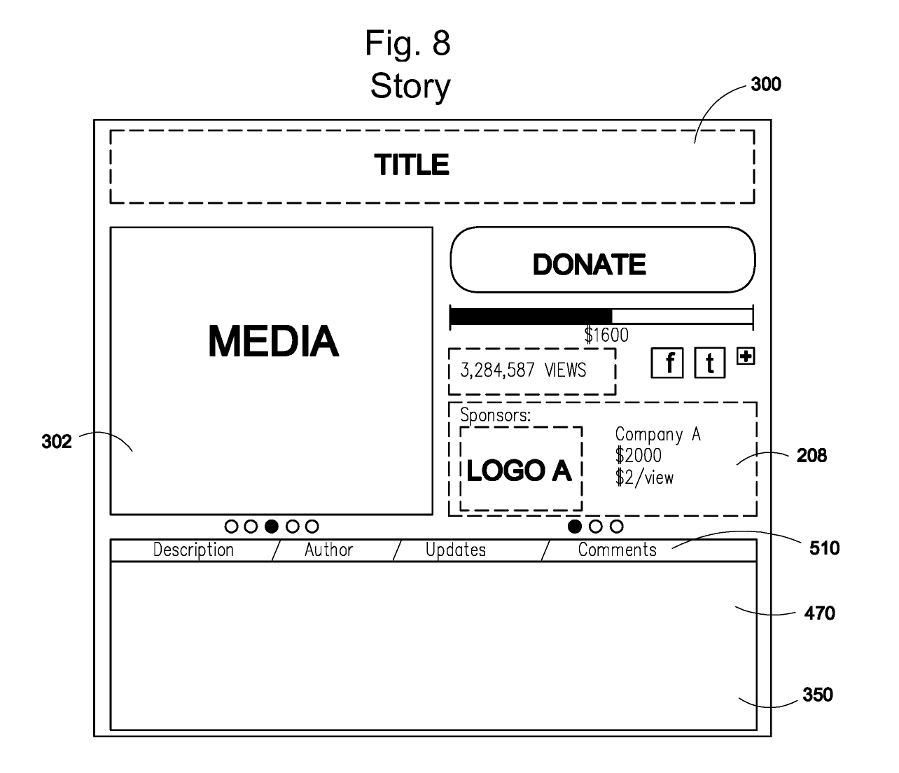

FIG. 9 shows an example screen depicting fundraising statuses of multiple stories;

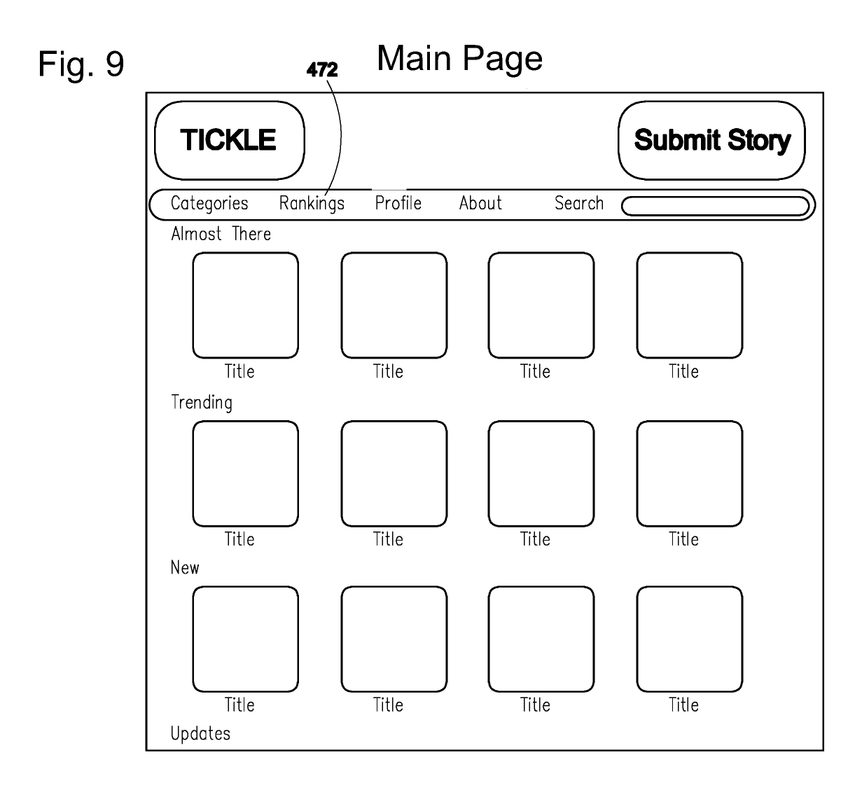

FIG. 10 shows an example screen presenting categories of stories from which the user may select;

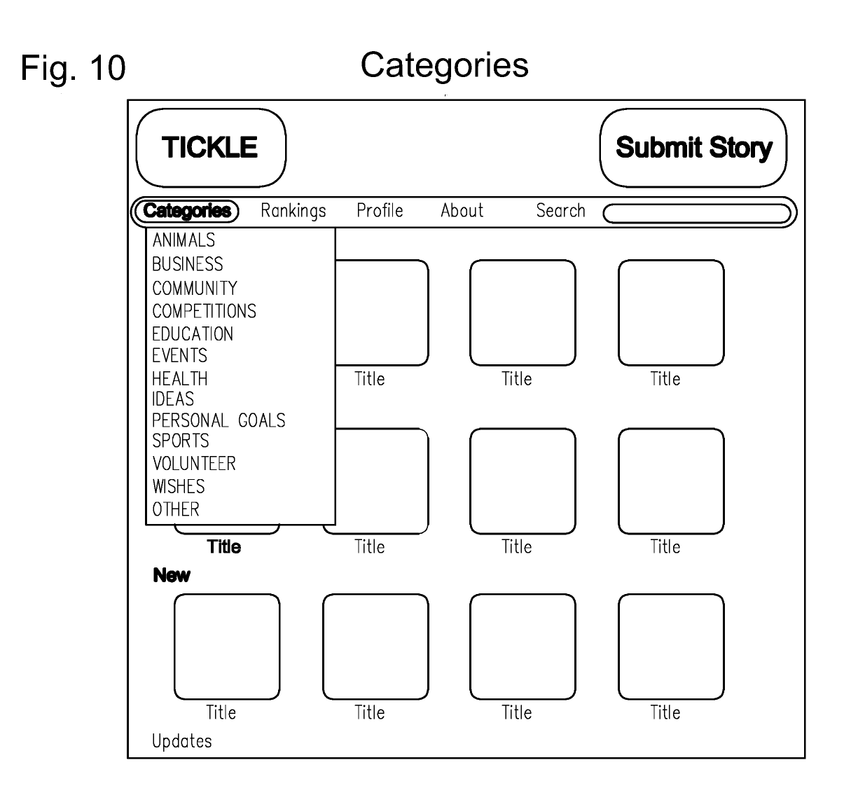

FIG. 11 provides a schematic outlining a first arrangement whereby a viewer is paid for viewing a particular story;

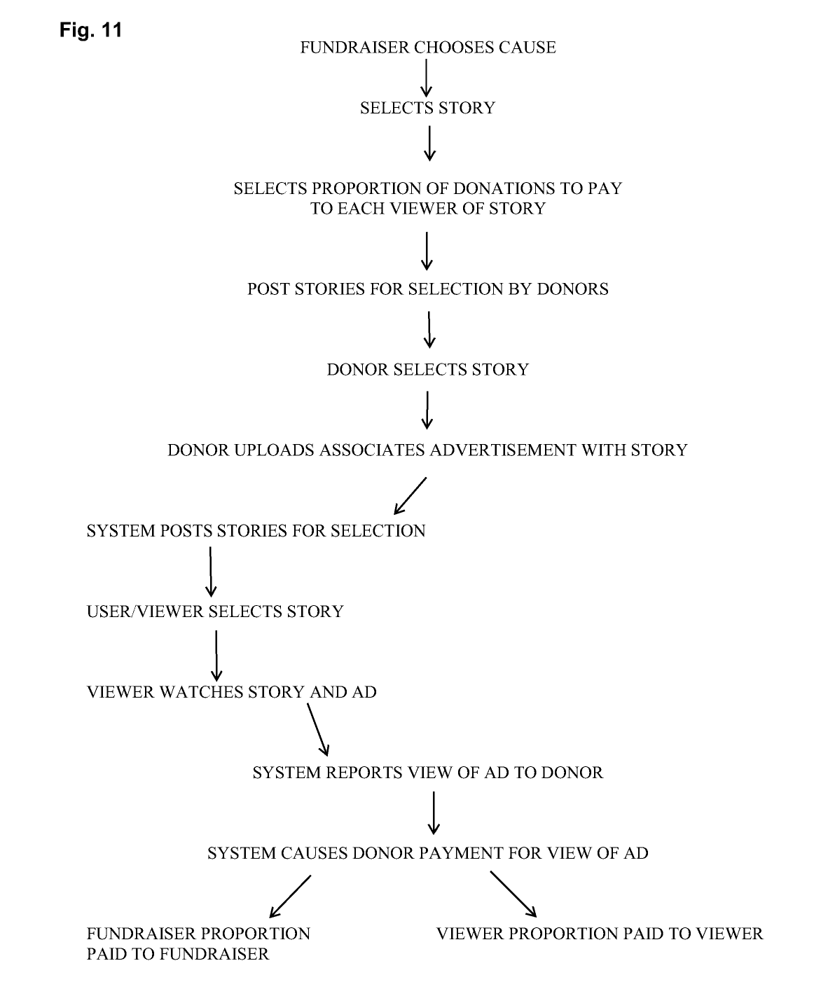

### DETAILED DESCRIPTION OF THE PREFERRED EMBODIMENT

The present invention comprises an on-line system 100 to facilitate and manage fundraising efforts for specified causes 204. The system 100 provides an online community 200 comprising at least one fundraiser 202 each said fundraiser having a cause 204, at least one user 206, and, at least one donor 208. The system further comprises at least one story 300, and at least one advertisement 302 said at least one advertisement 302 selected by at least one of said fundraisers 202. The system 100 provides a platform and functionality for raising funds 210 which are donated by a donor 208 in response to an action of one of the users 206.

The system 100 may include all or some of the following functions: user registration 400, sponsor company registration 450, fundraiser story selection 460. The fundraiser 202 registers, then prepares and/or selects at least one story 300 aligned with its cause 204. Next, a donor 208 selects a story 300 posted by a fundraiser 202 and uploads an advertisement 302 (or selects an advertisement 302 previously loaded) to be shown each time the donor's selected story 300 is viewed by a user 206. The donor 208 also elects a level of donation 500 for each view of the advertisement 302 by a user 206. The level of donation 500 may change based on the number of views of the ad 302. To that end, the system 100 may comprise a view counter 501. In one embodiment, the donor 208 may also select a limit or cap of total donations 500a and/or deposit only a set amount 500b. The system 100 comprises functionality to track the number of views of the ad 302 and amount of donation 500 per view of that ad 302 from that donor 208. When the limit or cap of total donations 500a is reached and then the next user 206 selects the story 300 aligned with the cause 204, the system 100 may send a message that the associated ad 302 is no longer available or may allow the ad 302 to be shown, however, no donation 500 will be debited from the deposit 500b made by the donor 208. When the level of total donations 502 has met a predetermined limit 500a or deposit 500b set by the donor 208, no additional donations will be recorded by the system. Each time the ad 302 is viewed, the system 100 computes the total donated by that donor 208 (or the limit 500a set for donation by the donor) for the ad 302 and compares it to the donation limit 500a set by the donor 208. When the total donated 502 equals the donation limit 500a, the system 100 no longer debits donations from the deposit 500a. In some embodiments, once the donation limit 500a is met, the system 100 stops allowing views of the ad.

In another embodiment, a user 206 selects one of the stories 300 and views at least a portion of the story 300 and at least one of the advertisements 302 associated by a donor 208 with that story 300. When the advertisement 302 has been viewed by the user 206, the system 100 notifies the donor 208 and the donor 208 donates funds 210 in accordance with the level of donation 500 pre-selected by the donor. Alternatively, the donor 208 deposits the total amount 500a it is willing to donate, and each time the story 300 is selected and its ad 302 is viewed, the system debits the deposited amount 500a by the amount of the preset donation 500, until the deposited amount 500b reaches zero or until a predetermined time limit is reached. If the time limit is reached and some of the predeposited funds 500b remain, the system may be configured to compute and refund the remainder of the funds 500b to the donor 208. Alternatively, the system 100 records the number of donations and periodically notifies the donor 208 of the amount owed, and provides functionality allowing the donor 208 to deactivate its ad (and thereby cap its donation amount).

The system may include a view counter 501 to count the number of times a story 300 and/or an ad 302 has been viewed and/or means 470 for a user/viewer 206 to enter a rating 472 of the ad 302 or story 300 or provide a review 472 of the ad 302 or story 300, or any or all of the above. Means to rate/review the ad 470 (or story 300) may comprise a tabulator function 475 to gather and/or post the ratings 472 and reviews. These ratings 472 may be used internally by the fundraiser 202 to determine and monitor the success of its efforts to raise funds and adjust its story 300 and/or selection of donors 208. The ratings 472 for a given ad 302 (or story 300) may be posted where potential users/viewers 206 can see them and make story viewing selections accordingly. The ratings 472 for a given ad 302 or a given story 300 may be used by the system 100 to determine when the donation level 210 by the donor 208 should be adjusted, or to determine when predetermined thresholds of number of views or rating levels have been met, thereby causing the system to post a pre-selected category or comment 510 regarding the advertisement 302 to increase viewer 206 selection of the story 300 associated with that ad 302. Variations for each function may include changing the donation level 500 made by the donor 208 based on a total number of views of or based on the ratings 472 of the advertisement 302 posted by that donor 208. The system comprises tabulator 475 which may be flexible enough such that levels of donation may be triggered to increase based on a number of different metrics such as number of times an ad has been viewed, the ratings of the story provided by the users, the ratings of the ad provided by the users, the number of times the ad is viewed without its accompanying story, etc. Based on the ratings 472 of a story 300 and/or advertisement 302, a preselected category or comment 473 pertaining to that story 300 or advertisement 302 may be assigned to the relevant story 300 or advertisement 302. The system 100 may comprise a search engine or other means to allow a viewer 206 to search for stories based on the ratings 472 or comments 473 associated with the story, or based on the ratings 472 or comments 473 associated with the ad 302. The online community 200 may also or alternatively include means 350 for viewers 206 to post comments about a story 300 or ad 302 viewed, and may include a link from the comment to the story 300 or ad 302 viewed, thereby allowing the online community 200 to “push” views.

The system may also control a Facebook or other online community page where ratings of ads 302 and stories 300 are posted and from which a potential user/viewer may select a link to the system 100 to view the ad 302 and/or story 300, thereby taking advantage of social media tools already well-known to drive viewership (and fundraising).

Based on the ratings 472 of the story 300 or ad 302, or on the number of views of either or both, the system 100 may apply an algorithm 600 to calculate the amount of funds the donor owes to the fundraiser in a given time frame. The algorithm may be a direct relationship of per view fees for each view of the donor's advertisement, or may include varying per view amounts based on reaching different platforms of viewership. The algorithm may incorporate the viewer ratings 472 or comments 473 of the advertisement or of the story. In one embodiment, the donor is billed and pays through a bill pay function of the system. The algorithm 600 may further comprise functionality 610 to cause donation 500 to be sent to fundraiser 202 from fund 500b according to the number of views counted by view counter 501. The advertiser's advertisement 302 will not be available to viewers 206 if the donor 208 has not authorized payments of the owned funds.

In one embodiment, the system allows a viewer 206 to post a question for the donor 208 about the story 300, and for the donor 208 to respond.

In an alternative embodiment of the system, the fundraiser 202 has a cause 204 for which it intends to raise funds. The fundraiser 202 selects a story 300 aligned with the cause 204. The fundraiser 202 also elects or specifies a proportion 700 of the potential donations 500 received that it is willing to pay over to a user 206 or users that view the story 300. The donor 208 then selects one of the fundraiser's stories 300 and uploads its (donor's) ad 302 to be associated with the story 300. Thereafter, the system posts stories 300 selected by donors 208 for selection by users 206, a user 206 selects and views the story 300 and the donor's associated ad 302. The system 100 tabulates the number of users 206 who view the story 300 and ad 302. The donor 208 donates funds 500 to the fundraiser 202 in an amount that is related to the number of views of the story 300 and/or ad 302. In this embodiment, the system 100 then applies the proportion 700 to divide the donated funds 500 between the user/viewer 206 of the story 300 and the fundraiser 202. Thereafter, the system 100 deposits the user's/viewer's 206 share of the donated funds 500 into a user/viewer account 710. In another embodiment, the system also deposits the fundraiser's 202 share 702 of the donated funds 500 into a fundraiser's account 704.

In a further embodiment, the fundraiser 202 has a cause and elects a story 300, however, story 300 is selected for its entertainment value rather than a link or association with the cause 204 per se. A donor 208 then selects the story 300, uploads its ad 302 and associates the ad 302 with the story 300, optionally sets its donation 500 level which may include a cap or floor 500a, and, thereafter, pays over its donation 500 in accordance with the number of users 206 who view the story until the cap 500a, if any, is met. In some embodiments, no donation 500 is made by the donor 208 unless the user 206 views the story 300 and the ad 302. In these embodiments, the proportion 700 may also be applied to divide the donated funds 500 between user/viewer 206 and the fundraiser 202.

We claim:

1. An online system for fundraising said system comprising:
a. at least one fundraiser and a proportion of donations said fundraiser is willing to share with a user in exchange for viewing a story;
b. a plurality of stories from which each said fundraiser may make a selection, said selection thereafter associated with said fundraiser;
c. at least one advertisement;
d. said system further comprising at least one donor selection, wherein each said donor selection comprises at least one of said plurality of stories associated with said fundraiser and at least one of at least one advertisement;
e. said system further comprising means to calculate and pay over said proportion of the donations to the user when the ad in the donor selection is viewed by the user.

2. An online system for fundraising said system comprising:
a) a story;
b) an ad associated with a donor, said donor willing to donate to a fundraiser an amount related to the number of views of the ad;
c) means to electronically present the story to a viewer;
d) an electronic link between the ad and said story, said ad thereby also presented to the viewer of said story;
e) a billed amount related to the number of views of the ad;
f) means to process payment (or cause transfer of?) of at least a portion of the billed amount from the donor to the fundraiser and at least another portion of the billed amount from the donor to the viewer.

3. The online system of claim 1 wherein a list of said plurality of stories is presented from which said donor selects a story, said system further comprising means to accept a viewer's selection of a story from the list thereafter presenting the story and at least one donor's advertisement associated with said story.

4. The online system of claim 2 said means to process payment comprising means to calculate and pay over said portion of donations to the viewer after said donor's ad is presented to the viewer.

5. The online system of claim 4 wherein means to bill comprises PayPal.
